(19) United States
(12) Patent Application Publication
(10) Pub. No.: US 2021/0291732 A1
(43) Pub. Date: Sep. 23, 2021

(54) VEHICULAR ELECTRONIC DEVICE AND METHOD OF OPERATING THE SAME

(71) Applicant: LG ELECTRONICS INC., Seoul (KR)

(72) Inventors: Hoonje WOO, Seoul (KR); Duckgee PARK, Seoul (KR); Jaesaek OH, Seoul (KR)

(73) Assignee: LG ELECTRONICS INC., Seoul (KR)

(21) Appl. No.: 17/259,657

(22) PCT Filed: Jul. 3, 2019
(86) PCT No.: PCT/KR2019/008129

§ 371 Date: Jan. 12, 2021

(51) Int. Cl. B60Q 9/00; B60Q 5/00; B60W 40/04; B60W 60/00; G08G 1/00; H04W 4/46; H04W 4/02

(52) U.S. Cl. CPC B60Q 9/00; B60Q 5/005; B60W 40/04; B60W 60/00; B60W 2554/4041; H04W 4/46; H04W 4/025; B60W 2556/65; B60W 2554/4029; G08G 1/22

(57) ABSTRACT

Disclosed is a vehicular electronic device including a processor which, in the situation in which an autonomous vehicle generates a horn signal during autonomous driving, determines a horn-signal-transmitting entity and a horn-signal-receiving entity, selects at least one of a horn signal in an audible frequency band or a horn signal in an inaudible frequency band, and outputs the selected horn signal to the horn-signal-receiving entity.

### TECHNICAL FIELD

The present disclosure relates to a vehicular electronic device and a method of operating the vehicular electronic device.

### BACKGROUND ART

A vehicle is an apparatus that carries a passenger in the direction intended by the passenger. A car is the main example of such a vehicle. An autonomous vehicle is a vehicle that is capable of traveling autonomously without driving operation by a human.

Conventionally, a horn of a car has been aimed at providing information about driving conditions or situations through audible notification between drivers or between a driver and a pedestrian.

However, a horn of an autonomous vehicle is used in the situation in which a human driver or a machine selectively serves as a driving entity. Thus, a conventional horn, which provides information through audible notification between humans, is not suitable for autonomous driving.

### DISCLOSURE

### Technical Problem

Therefore, the present disclosure has been made in view of the above problems, and it is an object of the present disclosure to provide a horn control device that determines a horn-signal-generating situation based on a specific driving entity in the situation in which a human driver or a machine selectively serves as a driving entity.

It is another object of the present disclosure to provide a horn control device that divides a horn signal of an autonomous vehicle into a horn signal in an audible frequency band and a horn signal in an inaudible frequency band, generates a horn signal in a frequency band suitable for a specific entity, and also exchanges specific information with the entity.

It is a further object of the present disclosure to provide a horn control device that determines a horn-signal-generating situation based on the determination of the location of an autonomous vehicle in the situation in which a human and another machine are present near the autonomous vehicle.

However, the objects to be accomplished by the disclosure are not limited to the above-mentioned objects, and other objects not mentioned herein will be clearly understood by those skilled in the art from the following description.

### Technical Solution

In accordance with an aspect of the present disclosure, the above objects can be accomplished by the provision of a vehicular electronic device included in an autonomous vehicle having a horn-signal-generating function during autonomous driving, the vehicular electronic device including a processor which determines whether a horn-signal-transmitting entity is a human or a machine, determines whether a horn-signal-receiving entity is a human or a machine, selects at least one of a horn signal in an audible frequency band or a horn signal in an inaudible frequency band based on the determination results, and outputs a horn signal in the selected frequency band to the horn-signal-receiving entity.

The vehicular electronic device according to the present disclosure may include a processor which transmits at least one piece of driving-related information selected from among information about a driving situation, information about a driving state, information about a vehicle driving direction, and information to request from another vehicle to the horn-signal-receiving entity simultaneously with outputting a horn signal in the selected frequency band.

The vehicular electronic device according to the present disclosure may further include a communicator which exchanges the at least one piece of driving-related information using V2V communication between autonomous vehicles, and an interface which receives a signal transmitted from an inaudible frequency band transceiver mounted in the autonomous vehicle.

The vehicular electronic device according to the present disclosure may include a processor which determines the location of the autonomous vehicle using driving speed data and GPS data, and transmits a horn signal in the audible frequency band or a horn signal in the inaudible frequency band based on the determination.

In accordance with another aspect of the present disclosure, there is provided a method of operating a vehicular electronic device included in an autonomous vehicle having a horn-signal-generating function during autonomous driving, the method including determining a horn-signal-transmitting entity and a horn-signal-receiving entity, selecting at least one of a horn signal in an audible frequency band or a horn signal in an inaudible frequency band based on the result of determining the entities, and outputting a horn signal in the selected frequency band to the horn-signal-receiving entity.

Details of other embodiments are included in the detailed description and the accompanying drawings.

### Advantageous Effects

According to the present disclosure, there are one or more effects as follows.

First, a processor according to the present disclosure may determine a horn-signal-transmitting entity and a horn-signal-receiving entity, and may generate a horn signal suitable for the entities in the situation in which a human driver or a machine selectively serves as a driving entity, thus enabling utilization of a horn during autonomous driving.

Second, a processor according to the present disclosure may generate a horn signal in an audible frequency band or a horn signal in an inaudible frequency band according to a horn-signal-receiving entity and may also transmit driving-related information to the horn-signal-receiving entity.

Third, a communicator according to the present disclosure may enable the exchange of driving-related information between autonomous vehicles through V2V communication, and may utilize a horn signal in an inaudible frequency band as an event at the initial stage of communication through the V2V communication.

However, the effects achievable through the disclosure are not limited to the above-mentioned effects, and other effects not mentioned herein will be clearly understood by those skilled in the art from the appended claims.

### DESCRIPTION OF DRAWINGS

FIG. 1 is a view showing the external appearance of a vehicle according to an embodiment of the present disclosure.

FIG. 2 is a view showing the external appearance of the vehicle according to the embodiment of the present disclosure when viewed from a different angle.

FIG. 3 is a control block diagram of the vehicle according to the embodiment of the present disclosure.

FIG. 4 is a control block diagram of a vehicular electronic device according to an embodiment of the present disclosure.

FIG. 5 is a diagram showing a horn signal in an audible or inaudible frequency band generated depending on a horn-signal-transmitting entity and a horn-signal-receiving entity according to the embodiment of the present disclosure.

FIGS. 6a to 6c are diagrams showing a horn signal transmission process depending on the entity according to the embodiment of the present disclosure.

FIGS. 7a to 11b are views showing a process of transmitting information between autonomous vehicles according to the embodiment of the present disclosure.

### BEST MODE

Hereinafter, the embodiments disclosed in the present specification will be described in detail with reference to the accompanying drawings, and the same or similar elements are denoted by the same reference numerals even though they are depicted in different drawings and redundant descriptions thereof will be omitted. In addition, the accompanying drawings are provided only for a better understanding of the embodiments disclosed in the present specification and are not intended to limit the technical ideas disclosed in the present specification. Therefore, it should be understood that the accompanying drawings include all modifications, equivalents and substitutions included in the scope and sprit of the present disclosure.

Terms including ordinal numbers such as first, second, etc. may be used to explain various elements. However, it will be appreciated that the elements are not limited to such terms. These terms are merely used to distinguish one element from another.

It will be understood that when an element is referred to as being “connected” or “coupled” to another element, it can be directly connected or coupled to the other element or intervening elements may be present.

The expression of singularity includes a plural meaning unless the singularity expression is explicitly different in context.

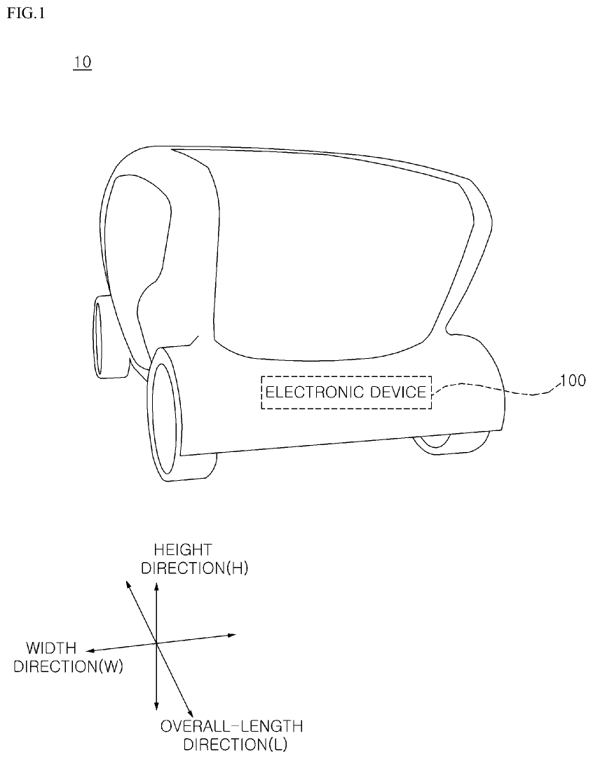

FIG. 1 is a view showing a vehicle according to an embodiment of the present disclosure.

Referring to FIG. 1, a vehicle 10 according to an embodiment of the present disclosure is defined as a transportation means that travels on a road or on rails. The vehicle 10 conceptually encompasses cars, trains, and motorcycles. The vehicle 10 may be any of an internal combustion vehicle equipped with an engine as a power source, a hybrid vehicle equipped with an engine and an electric motor as power sources, an electric vehicle equipped with an electric motor as a power source, and a vehicle equipped with a power source other than the above-described power sources. The vehicle 10 may be a shared vehicle. The vehicle 10 may be an autonomous vehicle.

The vehicle 10 may include an electronic device 100. The electronic device 100 may be a horn-signal-generating device, which will be described later.

The vehicle 10 may have a horn-signal-generating function. The horn-signal-generating function may be an operation of providing an audible notification between drivers or between a driver and a pedestrian. In the case in which the vehicle 10 is an autonomous vehicle, the horn-signal-generating function may be an operation of providing a notification between a human and a machine or between machines. The human may be a driver or a pedestrian, and the notification may be a horn signal in an audible frequency band or a horn signal in an inaudible frequency band.

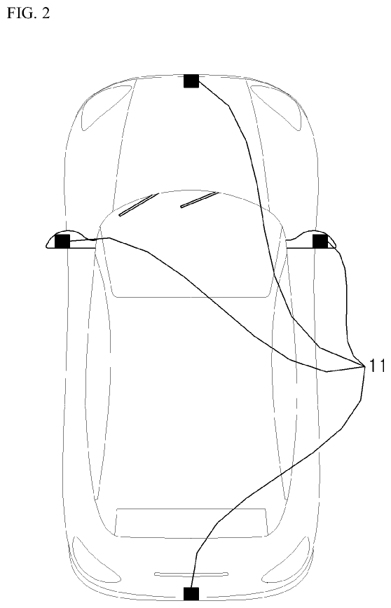

FIG. 2 is a view showing the vehicle according to the embodiment of the present disclosure when viewed at a different angle.

Referring to FIG. 2, the vehicle 10 according to the embodiment of the present disclosure may be equipped on front, rear, left and right sides thereof with inaudible frequency band transceivers 11, which may transmit and receive signals in an inaudible frequency band. The inaudible frequency band transceivers 11 may be used to transmit and receive a horn signal in an inaudible frequency band between vehicles as well as to exchange driving-related information between vehicles.

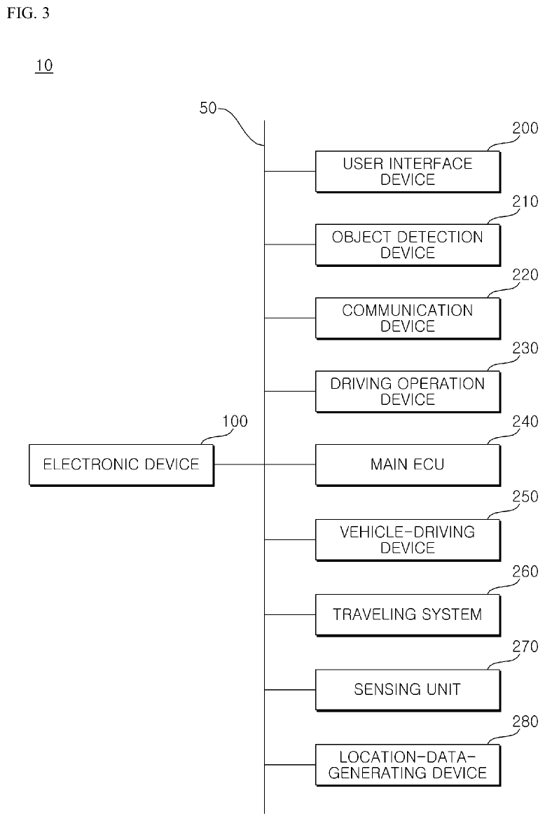

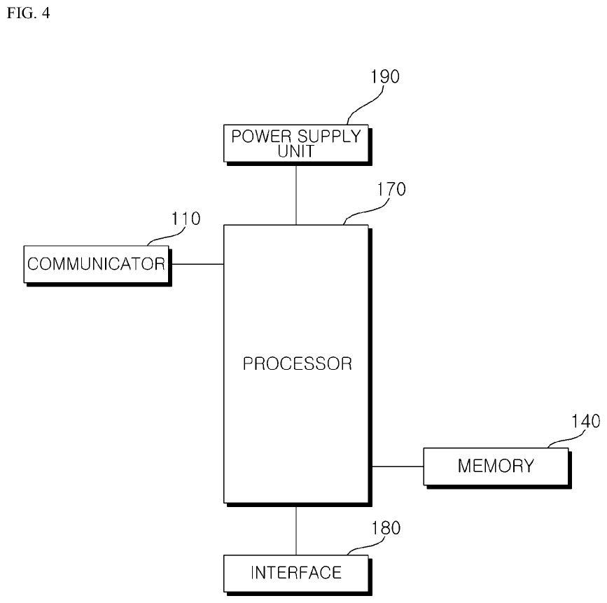

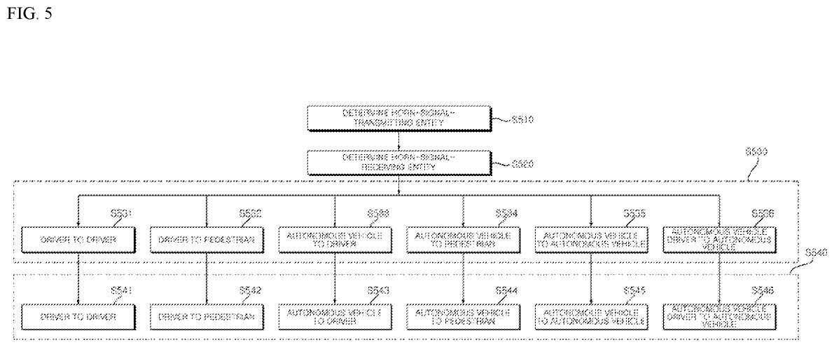

FIG. 3 is a control block diagram of the vehicle according to the embodiment of the present disclosure.

Referring to FIG. 3, the vehicle 10 may include a vehicular electronic device 100, a user interface device 200, an object detection device 210, a communication device 220, a driving operation device 230, a main ECU 240, a vehicle-driving device 250, a traveling system 260, a sensing unit 270, and a location-data-generating device 280.

The vehicular electronic device 100 may be a horn-signal-generating device that may exchange data with at least one external server. In this case, the communication device 220 may be used. In some embodiments, the vehicular electronic device 100 may include a communicator and may exchange data with an external server through the communicator.

The user interface device 200 is a device used to enable the vehicle 10 to communicate with a user. The user interface device 200 may receive information input by the user and may provide information generated by the vehicle 10 to the user, and the vehicle 10 may implement a User Interface (UI) or a User Experience (UX) through the user interface device 200.

The object detection device 210 is a device capable of detecting objects outside the vehicle 10. The object detection device 210 may include at least one detection device selected from among a camera, a radar, a lidar, an ultrasonic sensor, and an infrared sensor, and may provide data on an object, generated based on a signal generated by the detection device, to at least one electronic device included in the vehicle.

The communication device 220 is a device capable of exchanging a signal with a device located outside the vehicle 10. The communication device 220 may exchange a signal with at least one of an infrastructure element, such as a server or a broadcasting station, or another vehicle. In order to realize communication, the communication device 220 may include at least one of a transmission antenna, a reception antenna, a Radio-Frequency (RF) circuit capable of implementing various communication protocols, or an RF device.

The driving operation device 230 is a device that receives user input for driving the vehicle. In the manual mode, the vehicle 10 may travel based on a signal provided by the driving operation device 230. The driving operation device 230 may include a steering input device such as a steering wheel, an acceleration input device such as an accelerator pedal, and a brake input device such as a brake pedal.

The main ECU 240 may control the overall operation of at least one electronic device provided in the vehicle 10.

The vehicle-driving device 250 is a device that electrically controls the operation of various devices provided in the vehicle 10. The vehicle-driving device 250 may include a powertrain-driving unit, a chassis-driving unit, a door/window-driving unit, a safety-device-driving unit, a lamp-driving unit, and an air-conditioner-driving unit. The powertrain-driving unit may include a power-source-driving unit and a transmission-driving unit. The chassis-driving unit may include a steering-driving unit, a brake-driving unit, and a suspension-driving unit.

Meanwhile, the safety-device-driving unit may include a seat-belt-driving unit for controlling the seat belt.

The advanced driver assistance system (ADAS) 260 may generate a signal for controlling the movement of the vehicle 10 or outputting information to the user based on the data on an object received from the object detection device 210, and may provide the generated signal to at least one of the user interface device 200, the main ECU 240, or the vehicle-driving device 250.

The ADAS 260 may implement at least one of Adaptive Cruise Control (ACC), Autonomous Emergency Braking (AEB), Forward Collision Warning (FCW), Lane Keeping Assist (LKA), Lane Change Assist (LCA), Target Following Assist (TFA), Blind Spot Detection (BSD), High Beam Assist (HBA), Auto Parking System (APS), PD collision warning system, Traffic Sign Recognition (TSR), Traffic Sign Assist (TSA), Night Vision (NV), Driver Status Monitoring (DSM), or Traffic Jam Assist (TJA).

The sensing unit 270 may include at least one of an inertial measurement unit (IMU) sensor, a collision sensor, a wheel sensor, a speed sensor, an inclination sensor, a weight detection sensor, a heading sensor, a position module, a vehicle forward/reverse movement sensor, a battery sensor, a fuel sensor, a tire sensor, a steering sensor for detecting rotation of the steering wheel, a vehicle internal temperature sensor, a vehicle internal humidity sensor, an ultrasonic sensor, an illuminance sensor, an accelerator pedal position sensor, or a brake pedal position sensor. The inertial measurement unit (IMU) sensor may include at least one of an acceleration sensor, a gyro sensor, or a magnetic sensor.

The sensing unit 270 may generate data on the state of the vehicle based on the signal generated by at least one sensor. The sensing unit 270 may generate sensing signals of vehicle attitude information, vehicle motion information, vehicle yaw information, vehicle roll information, vehicle pitch information, vehicle collision information, vehicle heading information, vehicle angle information, vehicle speed information, vehicle acceleration information, vehicle inclination information, vehicle forward/reverse movement information, battery information, fuel information, tire information, vehicle lamp information, vehicle internal temperature information, vehicle internal humidity information, a steering wheel rotation angle, vehicle external illuminance, the pressure applied to the accelerator pedal, the pressure applied to the brake pedal, and so on.

The sensing unit 270 may further include an accelerator pedal sensor, a pressure sensor, an engine speed sensor, an air flow sensor (AFS), an air temperature sensor (ATS), a water temperature sensor (WTS), a throttle position sensor (TPS), a top dead center (TDC) sensor, a crank angle sensor (CAS), a tension sensor of a seat belt, and so on.

The vehicle state information may be information generated based on data sensed by various sensors provided in the vehicle. For example, the vehicle state information may include vehicle attitude information, vehicle speed information, vehicle inclination information, vehicle weight information, vehicle heading information, vehicle battery information, vehicle fuel information, vehicle tire air pressure information, vehicle steering information, vehicle internal temperature information, vehicle internal humidity information, pedal position information, vehicle engine temperature information, and so on.

The location-data-generating device 280 may include at least one of a global positioning system (GPS) or a differential global positioning system (DGPS), and may generate data on the location of the vehicle 10 based on the signal generated by at least one of the GPS or the DGPS. In some embodiments, the location-data-generating device 280 may correct the location data based on at least one of the inertial measurement unit (IMU) of the sensing unit 270 or the camera of the object detection device 210.

The vehicle 10 may include an internal communication system 50. The electronic devices included in the vehicle 10 may exchange a signal via the internal communication system 50, and the internal communication system 50 may use at least one communication protocol such as CAN, LIN, FlexRay, MOST, and Ethernet.

FIG. 4 is a block diagram of the vehicular electronic device according to the embodiment of the present disclosure.

Referring to FIG. 4, the vehicular electronic device 100 may include a communicator 110, a memory 140, a processor 170, an interface 180, and a power supply unit 190.

The communicator 110 may exchange a signal with a mobile terminal or an external device. In order to realize communication, the communicator 110 may include at least one of a transmission antenna, a reception antenna, a Radio-Frequency (RF) circuit capable of implementing various communication protocols, or an RF device.

The communicator 110 may include a V2X communicator. The V2X communicator is a unit used for wireless communication with a server (Vehicle to Infrastructure (V2I)), another vehicle (Vehicle to Vehicle (V2V)), or a pedestrian (Vehicle to Pedestrian (V2P)). The V2X communicator may include an RF circuit capable of implementing a V2I protocol, a V2V protocol, and a V2P protocol.

The V2V communicator may transmit host vehicle information received from the sensing unit 270 to another vehicle and may receive other vehicle information, which is information about a predetermined area around the other vehicle, from the other vehicle. In this case, the other vehicle information may include location information of the other vehicle, the direction in which an obstacle (a vehicle or a pedestrian) within a predetermined radius from the other vehicle is located, and the distance from the other vehicle to the obstacle, and may further include information about a predetermined area around the other vehicle, collected by a sensing unit of a preceding vehicle.

The memory 140 is electrically connected to the processor 170. The memory 140 may store basic data for the units, control data for controlling the operation of the units, and data that is input and output, and may store data processed by the processor 170. The memory 140 may be implemented as at least one of read only memory (ROM), random access memory (RAM), erasable and programmable ROM (EPROM), a flash drive, or a hard drive, and may store various data for the overall operation of the electronic device 100, such as programs for processing or control in the processor 170. The memory 140 may be integrated with the processor 170. In some embodiments, the memory 140 may be configured as a lower-level component of the processor 170.

The interface 180 may exchange a signal with at least one of the object detection device 210, the communication device 220, the driving operation device 230, the main ECU 240, the vehicle-driving device 250, the ADAS 260, the sensing unit 270, or the location-data-generating device 280 in a wired or wireless manner. The interface 180 may be configured as at least one of a communication module, a terminal, a pin, a cable, a port, a circuit, an element, or a device.

The interface 180 may receive location data of the vehicle 10 from the location-data-generating device 280, may receive driving speed data from the sensing unit 270, and may receive data on objects around the vehicle from the object detection device 210. The interface 180 may receive, from the inaudible frequency band transceiver 11, a horn signal in an inaudible frequency band and data on driving-related information to be transmitted. The driving-related information may include at least one of information about a driving situation, information about a driving state, information about a vehicle driving direction, or information to request from another vehicle.

The power supply unit 190 may receive power from a power source (e.g. a battery) included in the vehicle 10, and may supply the power to each unit of the electronic device 100.

The processor 170 may be electrically connected to the memory 140, the communicator 110, the interface 180, and the power supply unit 190, and may exchange a signal with the same. The processor 170 may be implemented using at least one of application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, or electrical units for performing other functions.

The processor 170 may receive data, process data, generate a signal, and provide a signal while receiving power from the power supply unit 190. The processor 170 may receive information from other electronic devices in the vehicle 10 through the interface 180, or may provide a control signal to other electronic devices in the vehicle 10 through the interface 180.

The processor 170 may determine the identity of the horn-signal-transmitting entity received from the interface 180. The horn-signal-transmitting entity may be a driver or an autonomous vehicle. The processor 170 may determine the identity of the horn-signal-receiving entity through the object detection device 210. The horn-signal-receiving entity may be another vehicle, a driver of another vehicle, a pedestrian, or the like.

The processor 170 may set the situation in which a horn signal is to be generated during autonomous driving. For example, when the driver has information to request from another vehicle, when other objects are present together with the autonomous vehicle, or when it is necessary to share risk information with other vehicles at the time point at which a horn signal is generated, a horn signal may be generated.

The processor 170 may select whether to output a horn signal in an audible frequency band or a horn signal in an inaudible frequency band based on the determination of the horn-signal-transmitting entity and the horn-signal-receiving entity. For example, the processor may output a horn signal in an inaudible frequency band between autonomous vehicles, and may output a horn signal in an audible frequency band when a manual driving vehicle, a pedestrian, or other external objects are present near the autonomous vehicle.

Simultaneously with the output of a horn signal, the processor 170 may transmit a driver's request for yielding or changing a driving course to the horn-signal-receiving entity. For example, when a horn signal is output in a cut-in situation, the processor may transmit a driving course for interrupting the movement of the nearby autonomous vehicle that attempts to cut in line and reducing the distance to a preceding vehicle to prevent cut-in of the nearby autonomous vehicle.

The processor 170 may exchange predetermined information between vehicles through the inaudible frequency band transceiver 11, and the predetermined information may include information about a driving state, such as cut-in, drowsiness, or lane departure, information about a vehicle driving direction, information about a driving situation, such as parking, driving in a school zone, or driving in a narrow space, information to request from another vehicle, and the like.

A following autonomous vehicle may request information about the traffic conditions ahead of the vehicle from a preceding vehicle traveling in the same lane and may exchange the information with other vehicles. When an autonomous vehicle attempts to cut in to an adjacent lane, the autonomous vehicle may request another vehicle in the adjacent lane to yield or travel slowly, and may exchange information corresponding thereto with other vehicles. Upon detecting platooning performed in an adjacent lane, an autonomous vehicle may request permission from the leader vehicle of the platoon to join the platoon, and may exchange information corresponding thereto with other vehicles.

In addition, when a preceding vehicle travels slowly, an autonomous vehicle may request a following vehicle in the same lane to yield or travel slowly and may exchange information corresponding thereto with other vehicles. When suddenly changing lanes while traveling, an autonomous vehicle may exchange information about the reason for the lane change, such as the traffic conditions ahead of the vehicle or the occurrence of an emergency situation, with a following vehicle.

The processor 170 may distinguish a specific location of the vehicle 10 based on driving speed data received from the sensing unit 270 and global location information data received from the location-data-generating device 280. The specific location of the vehicle may be distinguished as follows: an area in which a pedestrian is likely to be present near an autonomous vehicle may be a general residential area, a school zone, a zone around a seniors' residence, a business zone, and the like, and an area in which another vehicle or another driver is likely to be present near an autonomous vehicle may be a general road, a highway, an expressway, and the like.

The processor 170 may use a horn signal in an audible frequency band or a horn signal in an inaudible frequency band in an area in which a pedestrian is likely to be present near an autonomous vehicle. For example, when entering a specific zone in which a pedestrian has a higher priority than a vehicle, an autonomous vehicle may detect a risk factor in the specific zone, may output a horn signal in an inaudible frequency band to a following autonomous vehicle, and may output a horn signal in an audible frequency band to the driver of the following autonomous vehicle or to the pedestrian.

In addition, in an area in which another vehicle or another driver is likely to be present near an autonomous vehicle, the autonomous vehicle may use, according to the speed thereof, an audible horn signal (a medium/low speed: 80 km/h or lower) or an inaudible horn signal (higher than 80 km/h and up to the maximum speed of the vehicle). For example, a horn signal in an audible frequency band may be output on a general road, and a horn signal in an inaudible frequency band may be output on a highway or an expressway. The current section may be sensed and measured by linking a GPS of a vehicle to a navigation system of a vehicle.

FIG. 5 is a diagram showing the generation of a horn signal in an audible frequency band or a horn signal in an inaudible frequency band depending on a horn-signal-transmitting entity and a horn-signal-receiving entity according to the embodiment of the present disclosure.

Referring to FIG. 5, the processor 170 may determine whether the horn-signal-transmitting entity is a driver or an autonomous vehicle (S510), and may determine whether the horn-signal-receiving entity is a driver, a pedestrian, or an autonomous vehicle (S520). In addition, depending on the determination of the entity (S530), at least one of the horn signal in an audible frequency band or the horn signal in an inaudible frequency band may be selectively output (S540).

The combinations of the horn-signal-transmitting entity and the horn-signal-receiving entity, which are determined by the processor, may include driver to driver (S531), driver to pedestrian (S532), autonomous vehicle to driver (S533), autonomous vehicle to pedestrian (S534), autonomous vehicle to autonomous vehicle (S535), and autonomous vehicle driver to autonomous vehicle (S536).

In the case of driver to driver (S531), the processor 170 may output a horn signal in an audible frequency band (S541). In the case of driver to pedestrian (S532), the processor 170 may output a horn signal in an audible frequency band (S542). In the case of autonomous vehicle to driver (S533), the processor 170 may output a horn signal in an audible frequency band or a horn signal in an inaudible frequency band (S543). In the case of autonomous vehicle to pedestrian (S534), the processor 170 may output a horn signal in an audible frequency band or a horn signal in an inaudible frequency band (S544). In the case of autonomous vehicle to autonomous vehicle (S535), the processor 170 may output a horn signal in an inaudible frequency band (S545). In the case of autonomous vehicle driver to autonomous vehicle (S536), the processor 170 may output a horn signal in an audible frequency band or a horn signal in an inaudible frequency band (S546).

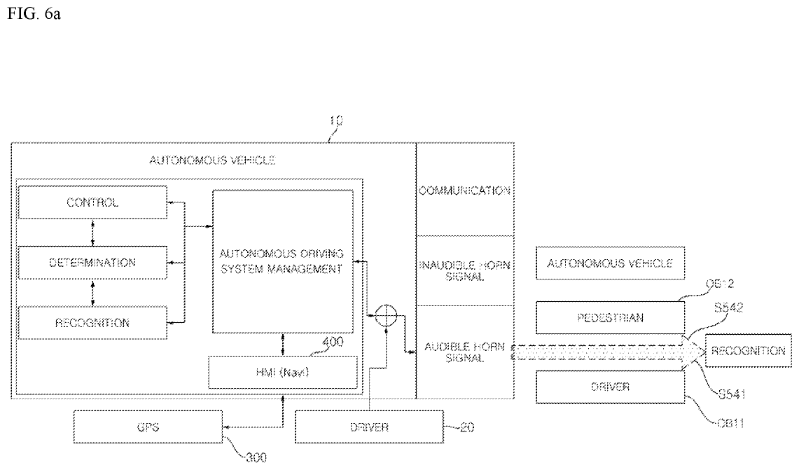

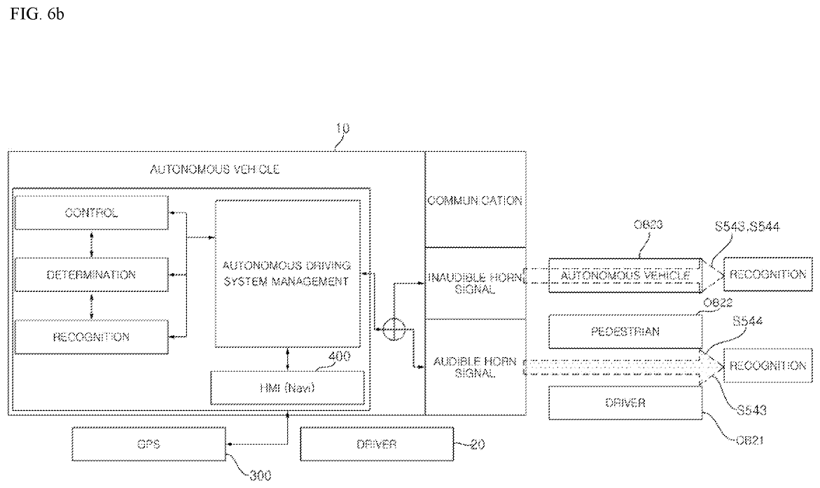

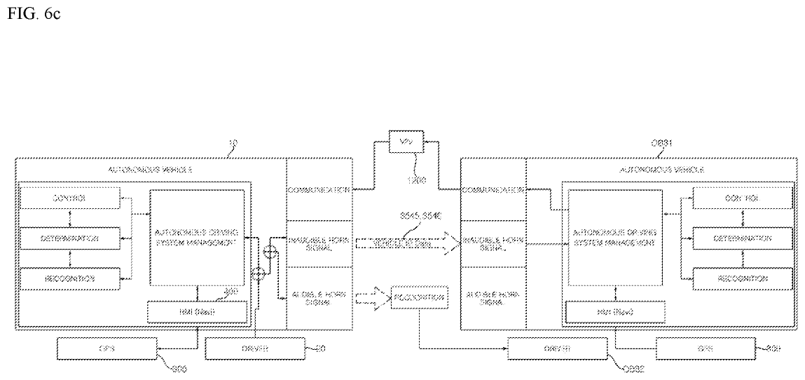

FIGS. 6a to 6c are diagrams showing a horn signal transmission process depending on the entity according to the embodiment of the present disclosure.

Referring to FIG. 6a, when the horn-signal-transmitting entity is a driver 20 of an autonomous vehicle and the horn-signal-receiving entity is a driver OB11, the driver 20 of the autonomous vehicle may transmit a horn signal in an audible frequency band as well as driving-related information such as information about a driving state to the driver OB11 of another vehicle in order to arouse the attention of the driver OB11 (S541). However, when driving the vehicle at a high speed on a highway or an expressway, the driver 20 of the autonomous vehicle may also transmit a horn signal in an inaudible frequency band.

The information about a driving state may include cut-in, drowsiness, lane departure, and the like.

When the horn-signal-transmitting entity is the driver 20 of the autonomous vehicle and the horn-signal-receiving entity is a pedestrian OB12, the driver 20 of the autonomous vehicle may transmit a horn signal in an audible frequency band as well as driving-related information such as information about a vehicle heading or a driving situation to the pedestrian ahead of, behind, or beside the host vehicle in order to arouse the attention of the pedestrian OB12 (S542).

The information about a driving situation may include parking, driving in a school zone, driving in a zone around a seniors' residence, driving in a narrow space, and the like.

Referring to FIG. 6b, when the horn-signal-transmitting entity is an autonomous vehicle 10 and the horn-signal-receiving entity is a driver OB21 of another vehicle, if the driver 20 of the autonomous vehicle does not generate a horn signal and the other vehicle driven by the driver OB21 is not an autonomous vehicle, the autonomous vehicle 10 may detect the current location and speed thereof and may transmit a horn signal in an audible frequency band as well as driving-related information such as information about a driving state to the driver OB21 of the other vehicle in order to arouse the attention of the driver OB21 of the other vehicle at a level suitable for the detection results. In this case, a horn signal in an inaudible frequency band may be output to another autonomous vehicle OB23 (S543).

The information about a driving state may include cut-in, drowsiness, lane departure, and the like.

When the horn-signal-transmitting entity is the autonomous vehicle 10 and the horn-signal-receiving entity is a pedestrian OB22, if the driver 20 of the autonomous vehicle does not generate a horn signal, the autonomous vehicle 10 may detect the current location and speed thereof and may transmit a horn signal in an audible frequency band as well as driving-related information such as information about a vehicle heading or a driving situation to the pedestrian OB22 ahead of, behind, or beside the host vehicle in order to arouse the attention of the pedestrian OB22 at a level suitable for the detection results. In this case, a horn signal in an inaudible frequency band may be output to another autonomous vehicle OB23 (S544).

The information about a driving situation may include parking, driving in a school zone, driving in a zone around a seniors' residence, driving in a narrow space, and the like.

Referring to FIG. 6c, when the horn-signal-transmitting entity is an autonomous vehicle 10 and the horn-signal-receiving entity is an autonomous vehicle OB31, the autonomous vehicle 10 may detect the current location and speed thereof on a highway or an expressway and may transmit a horn signal in an inaudible frequency band as well as driving-related information (S545). The communication between the autonomous vehicles may be V2V communication 1200.

A following autonomous vehicle may request information about the traffic conditions ahead of the vehicle from a preceding vehicle traveling in the same lane, and may exchange the information with other vehicles. When an autonomous vehicle attempts to cut in to an adjacent lane, the autonomous vehicle may request another vehicle in the adjacent lane to yield or travel slowly, and may exchange information corresponding thereto with other vehicles. Upon detecting platooning performed in an adjacent lane, an autonomous vehicle may request permission from the leader vehicle of the platoon to join the platoon, and may exchange information corresponding thereto with other vehicles.

In addition, when a preceding vehicle travels slowly, an autonomous vehicle may request a following vehicle in the same lane to yield or travel slowly and may exchange information corresponding thereto with other vehicles. When suddenly changing lanes while traveling, an autonomous vehicle may exchange information about the reason for the lane change, such as the traffic conditions ahead of the vehicle or the occurrence of an emergency situation, with a following vehicle.

When the horn-signal-transmitting entity is the driver 20 of the autonomous vehicle and the horn-signal-receiving entity is the autonomous vehicle OB31, if the driver 20 of the autonomous vehicle randomly generates a horn signal on a highway or an expressway, a horn signal in an audible frequency band or a horn signal in an inaudible frequency band as well as driving-related information such as information about a driving state may be transmitted (S546). In this case, the driver OB32 of the autonomous vehicle OB31 may receive the information about a driving state and the horn signal in an audible frequency band.

The information about a driving state may include cut-in, drowsiness, lane departure, and the like.

A following autonomous vehicle may request information about the traffic conditions ahead of the vehicle from a preceding vehicle traveling in the same lane and may exchange the information with other vehicles. When an autonomous vehicle attempts to cut in to an adjacent lane, the autonomous vehicle may request another vehicle in the adjacent lane to yield or travel slowly, and may exchange information corresponding thereto with other vehicles. Upon detecting platooning performed in an adjacent lane, an autonomous vehicle may request permission from the leader vehicle of the platoon to join the platoon, and may exchange information corresponding thereto with other vehicles.

In addition, when a preceding vehicle travels slowly, an autonomous vehicle may request a following vehicle in the same lane to yield or travel slowly and may exchange information corresponding thereto with other vehicles. When suddenly changing lanes while traveling, an autonomous vehicle may exchange information about the reason for the lane change, such as the traffic conditions ahead of the vehicle or the occurrence of an emergency situation, with a following vehicle.

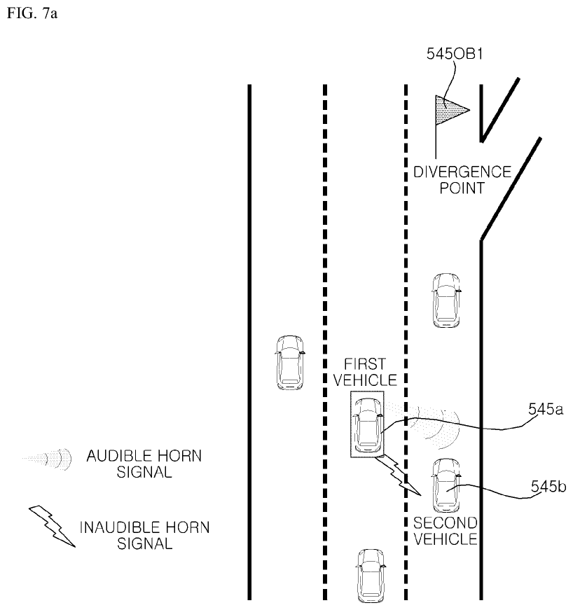

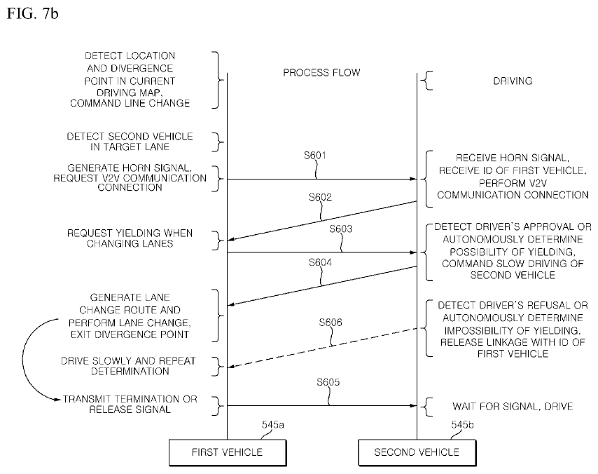

FIGS. 7a to 11b are views showing a process of transmitting information between autonomous vehicles according to the embodiment of the present disclosure.

Referring to FIGS. 7a and 7b, when a first vehicle 545a intends to leave the current lane in order to change lanes or to enter a divergence point 545OB1, there may occur the case in which a second vehicle 545b is present in an adjacent lane, to which the first vehicle 545a intends to move, while traveling side by side with the first vehicle 545a, behind the first vehicle 545a, or ahead of the first vehicle 545a.

The processor of the first vehicle 545a may detect the location of the first vehicle 545a and the divergence point 545OB1 in the current driving map. Upon receiving a lane change command, the processor of the first vehicle 545a may detect the second vehicle 545b in the target lane, to which the first vehicle 545a intends to move, may generate a horn signal in an audible or inaudible frequency band, and may request V2V communication with the second vehicle 545b (S601). The processor of the second vehicle 545b may receive the horn signal, may receive the ID of the first vehicle 545a, and may transmit a V2V communication connection completion signal (S602).

When the processor of the first vehicle 545a confirms the communication connection and transmits information about lane change and information about a request for yielding during lane change (S603), the processor of the second vehicle 545b may detect the approval of the driver of the host vehicle 545b or may autonomously determine the driving situation of the host vehicle 545b, and may issue a command for yielding and slow driving (S604). The processor of the first vehicle 545a may generate a route for lane change, may perform a lane change command, and may transmit a communication termination or release signal after passing through the divergence point 545OB1 (S605).

On the other hand, when the driver of the host vehicle 545b refuses the lane change, or upon determining that the host vehicle 545b is not able to yield due to the driving situation, the processor of the second vehicle 545b may provide information corresponding thereto and may release the linkage with the ID of the first vehicle 545a (S606).

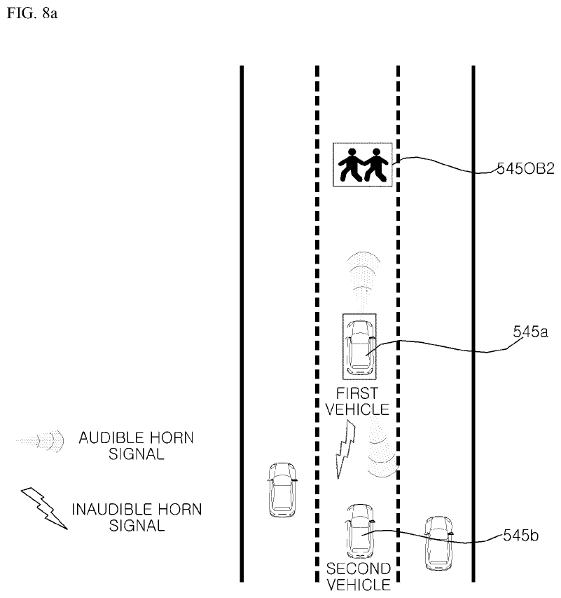

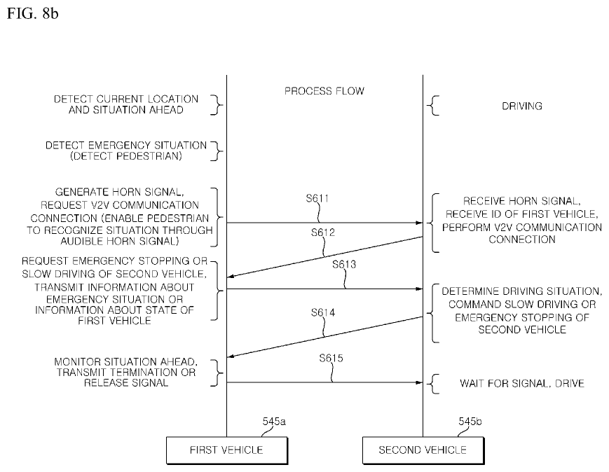

Referring to FIGS. 8a and 8b, in the situation in which an emergency situation, such as a pedestrian approaching, construction, or an accident, is detected ahead of the first vehicle 545a, there may occur the case in which a second vehicle 545b, which is traveling behind the first vehicle 545a, approaches close to the first vehicle 545a.

The processor of the first vehicle 545a may detect the current location of the first vehicle 545a and the situation ahead thereof. Upon detecting an emergency situation, the processor of the first vehicle 545a may generate a horn signal and may request V2V communication with the second vehicle 545b (S611). For example, when a pedestrian 545OB2 is detected ahead of the first vehicle 545a, the pedestrian 545OB2 may recognize the situation through a horn signal in an audible frequency band, and the processor of the second vehicle 545b may receive the horn signal, may receive the ID of the first vehicle, and may transmit a V2V communication connection completion signal (S612).

The processor of the first vehicle 545a may confirm the communication connection and may transmit information about a request for emergency stopping or slow driving, information about the emergency situation, and information about the state of the first vehicle 545a to the second vehicle 545b (S613). The processor of the second vehicle 545b may determine the driving situation and may issue a command for slow driving or emergency stopping of the second vehicle 545b (S614), and the processor of the first vehicle 545a may enter a standby state while monitoring the situation ahead of the first vehicle 545a, or may transmit a termination or release signal (S615).

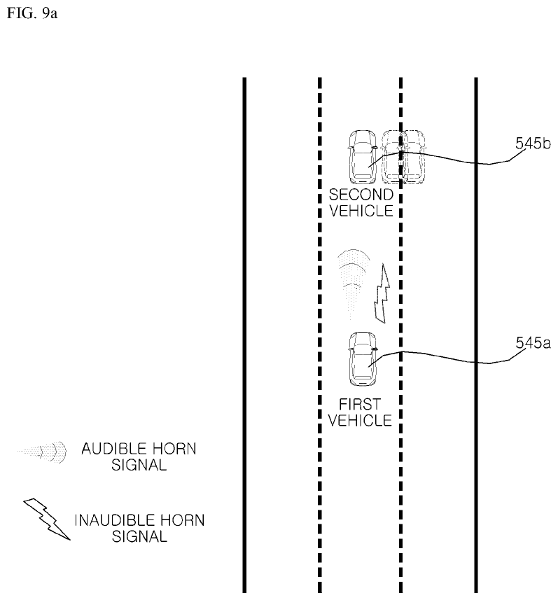

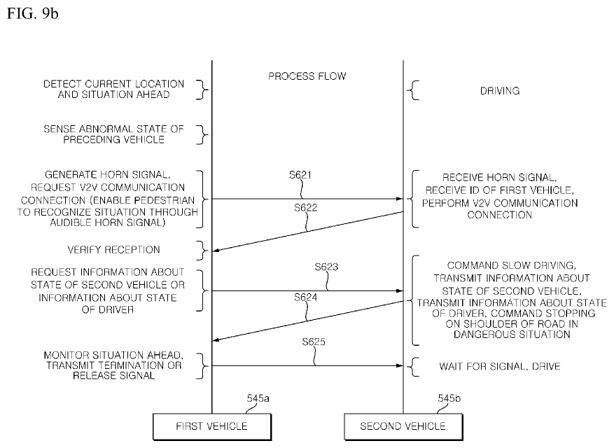

Referring to FIGS. 9a and 9b, there may occur the case in which an abnormal state of a second vehicle 545b, which is traveling ahead of the first vehicle 545a, is sensed.

The processor of the first vehicle 545a may detect the current location of the first vehicle 545a and the situation ahead thereof. Upon sensing an abnormal state of the second vehicle 545b, the processor of the first vehicle 545a may generate a horn signal and may request V2V communication with the second vehicle 545b (S621). The driver of the second vehicle 545b may recognize the situation through a horn signal in an audible frequency band, and the processor of the second vehicle 545b may receive the horn signal, may receive the ID of the first vehicle 545a, and may transmit a V2V communication connection completion signal (S622).

The processor of the first vehicle 545a may confirm the communication connection and may transmit a request for information about the state of the second vehicle 545b or information about the state of the driver of the second vehicle 545b (S623). The processor of the second vehicle 545b may issue a command for slow driving of the second vehicle 545b, may transmit the information about the state of the second vehicle 545b or the information about the state of the driver of the second vehicle 545b, and may issue a command for stopping on the shoulder of the road in a dangerous situation (S624), and the processor of the first vehicle 545a may enter a standby state while monitoring the preceding vehicle, or may transmit a termination or release signal (S625).

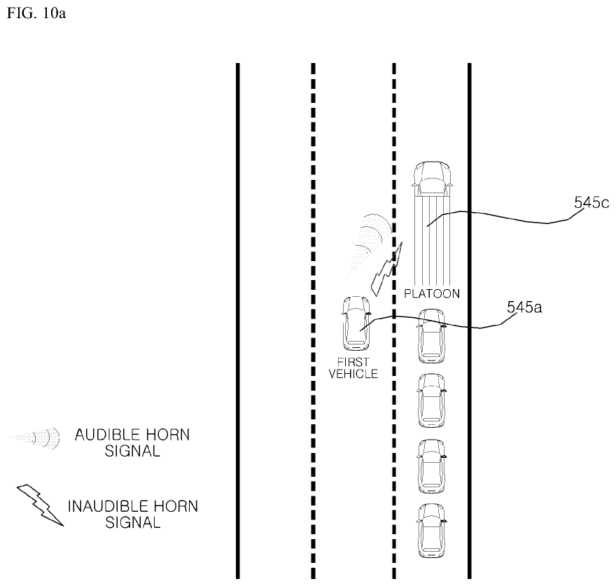

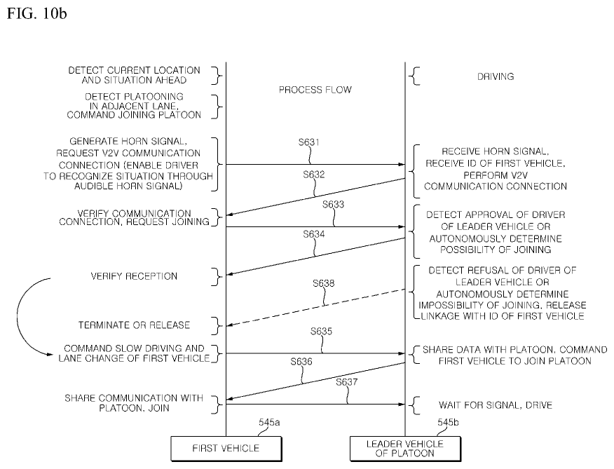

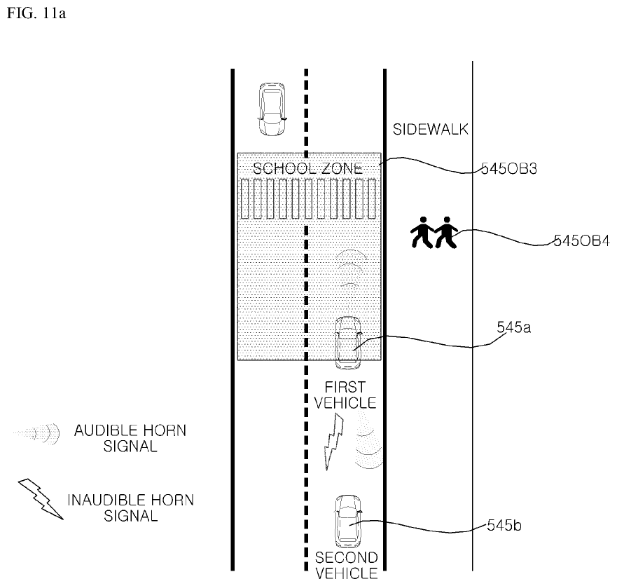

Referring to FIGS. 10a and 10b, in the situation of detecting platooning that is being performed in the lane adjacent to the lane in which the first vehicle 545a is traveling, there may occur the case in which the first vehicle 545a requests permission from a leader vehicle 545c of the platoon to join the platoon.

The processor of the first vehicle 545a may detect the current location of the first vehicle 545a and the situation ahead thereof. Upon sensing platooning in the adjacent lane, the processor of the first vehicle 545a may issue a command for joining the platoon, may generate a horn signal, and may request V2V communication with the leader vehicle 545b of the platoon (S631). The driver of the leader vehicle 545c of the platoon may recognize the situation through a horn signal in an audible frequency band, and the processor of the leader vehicle 545c of the platoon may receive the horn signal, may receive the ID of the first vehicle 545a, and may transmit a V2V communication connection completion signal (S632).

The processor of the first vehicle 545a may confirm the communication connection and may transmit information about a request for joining the platoon (S633), and the processor of the leader vehicle 545c of the platoon may determine the approval of the driver of the leader vehicle 545c of the platoon or may autonomously determine the possibility of joining in the platoon, and may transmit an approval signal (S634).

The processor of the first vehicle 545a may receive the approval signal and may issue a command for slow driving and lane change of the first vehicle 545a (S635), and the processor of the leader vehicle 545c of the platoon may share data with the other vehicles included in the platoon and may issue a command for joining of the first vehicle 545a (S636). The processor of the first vehicle 545a may communicate with the vehicles of the platoon and may join the platoon (S637).

On the other hand, when the driver of the leader vehicle 545c of the platoon refuses to allow the platoon to be joined, or upon autonomously determining that it is impossible to join the platoon, the processor of the leader vehicle 545c of the platoon may provide information corresponding thereto and may release the linkage with the ID of the first vehicle 545a (S638).

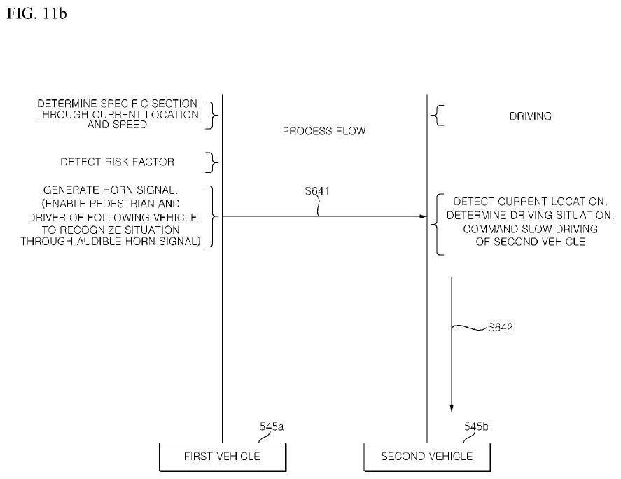

Referring to FIGS. 11a and 11b, in the situation in which the first vehicle 545a enters a specific section in which a pedestrian has right-of-way over a vehicle, e.g. a sidewalk 545OB4, a school zone 545OB3, or a crosswalk, there may occur the case in which a second vehicle 545b, which is traveling behind the first vehicle 545a, approaches close to the first vehicle 545a.

The processor of the first vehicle 545a may determine whether the current section in which the first vehicle 545a is traveling is a specific section in which a pedestrian has right-of-way over a vehicle based on the current location and speed of the first vehicle 545a. Upon determining that the current section is a specific region, the processor of the first vehicle 545a may detect a risk factor and may generate a horn signal. A pedestrian and the driver of the following vehicle may recognize the situation through a horn signal in an audible frequency band (S641). The processor of the second vehicle 545b may detect the current location of the second vehicle 545b, may determine the driving situation of the second vehicle 545b, and may issue a command for slow driving of the second vehicle 545b (S642).

The aforementioned present disclosure may be implemented as computer-readable code stored on a computer-readable recording medium. The computer-readable recording medium may be any type of recording device in which data is stored in a computer-readable manner. Examples of the computer-readable recording medium include a Hard Disk Drive (HDD), a Solid-State Disk (SSD), a Silicon Disk Drive (SDD), Read-Only Memory (ROM), Random-Access Memory (RAM), CD-ROM, magnetic tapes, floppy disks, optical data storage devices, carrier waves (e.g. transmission via the Internet), etc. In addition, the computer may include a processor or a controller. The above embodiments are therefore to be construed in all aspects as illustrative and not restrictive. It is intended that the present disclosure cover the modifications and variations of this disclosure provided they come within the scope of the appended claims and their equivalents.

1. A vehicular electronic device included in an autonomous vehicle having a horn-signal-generating function, the vehicular electronic device comprising:
a processor configured to:
determine whether a horn-signal-transmitting entity is a human or a machine,
determine whether a horn-signal-receiving entity is a human or a machine,
select at least one of a horn signal in an audible frequency band or a horn signal in an inaudible frequency band based on determinations as to the horn-signal-transmitting entity and the horn-signal-receiving entity, and
output the selected horn signal to the horn-signal-receiving entity.

2. The vehicular electronic device of claim 1, wherein the processor is configured to transmit at least one piece of driving-related information among information about a driving situation, information about a driving state, information about a vehicle driving direction, and information to request from another vehicle to the horn-signal-receiving entity with outputting the selected horn signal.

3. The vehicular electronic device of claim 2, wherein the processor is configured to output, upon determining that the horn-signal-transmitting entity is a driver of a host vehicle and upon determining that the horn-signal-receiving entity is a driver of another vehicle, the horn signal in the audible frequency band, and transmit the at least one piece of driving-related information.

4. The vehicular electronic device of claim 2, wherein the processor is configured to output, upon determining that the horn-signal-transmitting entity is a driver of a host vehicle and upon determining that the horn-signal-receiving entity is a pedestrian, the horn signal in the audible frequency band, and transmit the at least one piece of driving-related information.

5. The vehicular electronic device of claim 2, wherein the autonomous vehicle further comprises:
a communicator transmitting the at least one piece of driving-related information using V2V communication; and
an interface receiving a signal transmitted from an inaudible frequency band transceiver mounted in the autonomous vehicle.

6. The vehicular electronic device of claim 5, wherein the processor is configured to output, upon determining that the horn-signal-transmitting entity is an autonomous vehicle and upon determining that the horn-signal-receiving entity is a driver of another vehicle, the horn signal in the audible frequency band or the horn signal in the inaudible frequency band, and transmit the at least one piece of driving-related information.

7. The vehicular electronic device of claim 5, wherein the processor is configured to output, upon determining that the horn-signal-transmitting entity is an autonomous vehicle and upon determining that the horn-signal-receiving entity is a pedestrian, the horn signal in the audible frequency band or the horn signal in the inaudible frequency band, and transmit the at least one piece of driving-related information.

8. The vehicular electronic device of claim 5, wherein the processor is configured to output, upon determining that the horn-signal-transmitting entity is a driver of a host vehicle and upon determining that the horn-signal-receiving entity is an autonomous vehicle, the horn signal in the audible frequency band or the horn signal in the inaudible frequency band, and transmit the at least one piece of driving-related information.

9. The vehicular electronic device of claim 5, wherein the processor is configured to output, upon determining that the horn-signal-transmitting entity is an autonomous vehicle and upon determining that the horn-signal-receiving entity is an autonomous vehicle, the horn signal in the inaudible frequency band, and transmit the at least one piece of driving-related information.

10. The vehicular electronic device of claim 9, wherein, when the processor is configured to:
output, on receiving a signal for lane change, the horn signal in the inaudible frequency band to a vehicle in an adjacent lane as the horn-signal-receiving entity,
transmit information about an ID of the horn-signal-transmitting entity through the V2V communication,
transmit information about lane change and information about a request for yielding as the driving-related information,
receive an approval signal from the horn-signal-receiving entity, and
transmit a termination signal after changing lanes.

11. The vehicular electronic device of claim 9, wherein the processor is configured to:
output, on detecting an emergency situation ahead, the horn signal in the inaudible frequency band to a following vehicle as the horn-signal-receiving entity,
transmit information about an ID of the horn-signal-transmitting entity through the V2V communication,
transmit at least one of information about the emergency situation, information about a request for emergency stopping or slow driving, or information about a state of the horn-signal-transmitting entity as the driving-related information, and
transmit a termination signal when the horn-signal-receiving entity stops or drives slowly.

12. The vehicular electronic device of claim 9, wherein, when the processor is configured to:
output, on sensing an abnormal state of a preceding vehicle, the horn signal in the inaudible frequency band to the preceding vehicle as the horn-signal-receiving entity,
transmit information about an ID of the horn-signal-transmitting entity through the V2V communication,
request information about a state of the preceding vehicle or information about a state of a driver as the driving-related information, and
transmit a termination signal when receiving information about a state of the preceding vehicle or information about a state of a driver.

13. The vehicular electronic device of claim 9, wherein, when the processor is configured to:
output, on receiving a command for joining a platoon performing platooning, the horn signal in the inaudible frequency band to a leader vehicle of the platoon as the horn-signal-receiving entity,
transmit information about an ID of the horn-signal-transmitting entity through the V2V communication,
transmit information about a request for joining the platoon as the driving-related information,
receive an approval signal from the horn-signal-receiving entity, and
communicate with the platoon after joining the platoon.

14. The vehicular electronic device of claim 5, wherein the interface is configured to receive driving speed data from a sensor and receive GPS data from a location-data-generating device, and
wherein the processor is configured to determine a location of the autonomous vehicle using the driving speed data and the GPS data.

15. The vehicular electronic device of claim 14, wherein the processor is configured to output the horn signal in the audible frequency band or the horn signal in the inaudible frequency band based on a determination as to the location of the autonomous vehicle using the driving speed data and the GPS data.

16. The vehicular electronic device of claim 15, wherein the processor is configured to output, when the determined location is a location at which another vehicle is expected to be present near the autonomous vehicle, output the horn signal in the audible frequency band on a general road and the horn signal in the inaudible frequency band on a highway or an expressway.

17. The vehicular electronic device of claim 15, wherein the processor is configured to output, when the determined location is a location at which a pedestrian is expected to be present near the autonomous vehicle, the horn signal in the audible frequency band or the horn signal in the inaudible frequency band.

18. The vehicular electronic device of claim 17, wherein the processor is configured to:
detect, when the determined location is a location to enter a specific section of pedestrian priority, a risk factor in the specific section, and output the horn signal in the inaudible frequency band to a following vehicle as the horn-signal-receiving entity,
output the horn signal in the audible frequency band to a driver of the following vehicle as the horn-signal-receiving entity, and
transmit the at least one piece of driving-related information to the horn-signal-receiving entity.

19. A method of operating a vehicular electronic device included in an autonomous vehicle having a horn-signal-generating function during autonomous driving, the method comprising:
determining a horn-signal-transmitting entity and a horn-signal-receiving entity;
selecting at least one of a horn signal in an audible frequency band or a horn signal in an inaudible frequency band based on a result of determining the horn-signal-transmitting entity and the horn-signal-receiving entity; and
outputting the selected horn signal to the horn-signal-receiving entity.

20. The method of claim 19, further comprising:
transmitting at least one piece of driving-related information among information about a driving situation, information about a driving state, information about a vehicle driving direction, and information to request from another vehicle to the horn-signal-receiving entity with outputting the selected horn signal.
